(19) United States
(12) Patent Application Publication
(10) Pub. No.: US 2026/0176195 A1
(43) Pub. Date: Jun. 25, 2026

(54) BOROSILICATE FIBERGLASS INSULATION MATERIALS AND METHODS FOR MAKING AND USING THEM

(71) Applicant: CertainTeed LLC, Malvern, PA (US)

(72) Inventor: Pierre Lombard, Malvern, PA (US)

(21) Appl. No.: 19/428,158

(22) Filed: Dec. 20, 2025

Related U.S. Application Data
(60) Provisional application No. 63/736,931, filed on Dec. 20, 2024.

(51) Int. Cl. C03C 25/6266; C03C 13/00

(52) U.S. Cl. CPC C03C 25/6266; C03C 13/00; C03C 2203/50; C03C 2213/00

(57) ABSTRACT

The present disclosure relates generally to insulation materials and methods for making and using them. In one aspect, the disclosure provides a method for making a borosilicate fiberglass insulation material comprising a plurality of borosilicate glass fibers, the method comprising providing a borosilicate fiberglass comprising a plurality of borosilicate glass fibers; and irradiating the plurality of borosilicate glass fibers of the borosilicate fiberglass with an electron beam.

### BACKGROUND OF THE DISCLOSURE

### 1. Field of the Disclosure

The present disclosure relates generally to insulation materials and methods for making and using them. The present disclosure relates more particularly to borosilicate fiberglass insulation materials, methods for making them, and methods for using them.

### 2. Technical Background

Insulation materials such as bound fiberglass materials (e.g., in the form of batts, rolls or blankets) are typically used to reduce the rate of heat transfer between two areas separated by a boundary. For example, in an attic, insulation material can be applied to the interior surface of the roof deck to slow the transfer of heat through the roof deck, that is, from the exterior of the house to the attic or vice versa. In another application, insulation material is applied to exterior walls (e.g., between wood studs) and covered with wallboards to slow the rate of heat transfer through the exterior wall and the wallboard. Insulation material can also prevent undesirable air movement (e.g., convection drafts) and resultant movement of moisture from one space to another.

Mineral wool insulation materials are often formed in mat-like structures, with individual fibers being bound together in a non-woven structure by a binder. Such materials can be provided, e.g., in the form of batts, blankets or rolls, which can be disposed against building surfaces to insulate them. Such materials are typically disposed in attics (e.g., against a ceiling or a floor) or within walls to provide insulation.

More recently, the use of blowing fiberglass loose-fill insulation has increased in popularity. Loose-fill insulation is typically made up chiefly of non-bonded short glass fibers, typically treated with additives such as dedusting oils and antistatic compounds. Loose-fill insulation is typically compressed and packaged into bags. Installation is performed (e.g., into attics and sidewalls) using a pneumatic blowing machine; the blowing process desirably uncompresses the loose-fill insulation to provide it with a desired low density.

Loose-fill insulation is popular with insulation contractors because it can be easily and quickly applied in both new construction as well as in existing structures. Further, loose-fill insulation is a relatively low-cost material, and has lower labor costs to install as compared to materials in the form of batts, blankets and rolls. However, loose-fill insulation is typically applied by contractors rather than homeowners because of the special blowing equipment needed. Such insulation is typically packaged in large bags weighing, e.g., 20-40 lbs.

Further improvements in insulation materials are required, especially with respect to their insulating properties.

### SUMMARY OF THE DISCLOSURE

One aspect of the disclosure is a method for making a borosilicate fiberglass insulation material comprising a plurality of borosilicate glass fibers, the method comprising:
providing a borosilicate fiberglass comprising a plurality of borosilicate glass fibers; and
irradiating the plurality of borosilicate glass fibers of the borosilicate fiberglass with an electron beam.

Another aspect of the disclosure is a borosilicate fiberglass insulation material comprising a plurality of electron beam-irradiated borosilicate glass fibers.

Another aspect of the disclosure is an insulated structure having an interior surface (e.g., a surface of a wall, a ceiling, floor, an attic, a basement, or another building surface), and a borosilicate fiberglass insulation material as described herein disposed against the interior surface.

Another aspect of the disclosure is an insulated structure having an interior surface and an exterior surface, and a borosilicate fiberglass insulation material as described herein disposed in and at least partially filling a cavity between the interior surface and the exterior surface.

Another aspect of the disclosure is an insulated cavity having an interior surface and an exterior surface, and a borosilicate fiberglass insulation material as described herein disposed in and a least partially filling (e.g., substantially filling) the cavity between the interior surface and the exterior surface.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic view of an insulated structure according to one embodiment of the disclosure.

FIG. 2 is a schematic view of an insulated structure according to another embodiment of the disclosure.

### DETAILED DESCRIPTION

The present inventors have noted that borosilicate glasses have conventionally been used as glass fiber materials in insulation products. Boron is included in the glass to provide a variety of desirable attributes, including glass processability and material properties such as strength. The present inventors have noted that the amount of a particular type of boron (i.e., tricoordinate boron) can improve the ability of glass to absorb infrared radiation, which is a component of heat transmittance. The higher the content of the tricoordinate boron, the better the ability of glass to absorb infrared radiation and so, the higher the insulation performance.

However, boron can be a relatively expensive raw material, and as such it can be desirable to reduce the amount of boron in a glass used as a fiberglass insulation.

The present inventor has noted that boron primarily exists in a glass material in one of two configurations: The so-called “BO3” configuration, in which it is bonded to 3 oxygens, and the so-called “BO4” configuration, in which it is bonded to 4 oxygens. It is the BO3 configuration that absorbs infrared radiation in a wavelength range appropriate for insulation purposes. The ratio of BO3 to BO4 depends, in part, on other components of the borosilicate glass (e.g., sodium, potassium, aluminum). While it is, in theory, possible to increase the infrared absorption of the glass by changing the overall glass formulation, in practice this is difficult because insulation fiber glass formulations are tuned to satisfy a wide variety of requirements, such as manufacturability and biosolubility.

The present inventors have noted that electron beam irradiation can be used to increase the proportion of BO3 in borosilicate glasses. This can provide a method to increase the infrared absorbance of the glass without a change in the glass formulation itself. Moreover, this can be performed after the glass is melted and fiberized, and so even if there are changes in the properties of the glass upon electron beam radiation, they would not strongly impact manufacturing.

Accordingly, one aspect of the disclosure is method for making a borosilicate fiberglass insulation material comprising a plurality of borosilicate glass fibers, the method including: providing a borosilicate fiberglass comprising a plurality of borosilicate glass fibers; and irradiating the plurality of borosilicate glass fibers of the borosilicate fiberglass with an electron beam. Another aspect of the disclosure is a borosilicate fiberglass insulation material made by a method as described herein. Another aspect of the disclosure is a borosilicate fiberglass insulation material comprising a plurality of electron beam-irradiated borosilicate glass fibers. Another aspect of the disclosure is a borosilicate fiberglass insulation material comprising a plurality of borosilicate glass fibers, the plurality of borosilicate glass fibers having a BO3/BO4 ratio of at least 0.77. As demonstrated below, the present inventors have determined that irradiation with an electron beam can increase the BO3 content of the glass, and therefore that such treatment can decrease the thermal conductivity of an insulation material that includes electron beam-irradiated borosilicate glass fibers. The borosilicate fiberglass insulation materials described herein can be useful as loose-fill insulation materials or bound insulation material in the form, e.g., of batts, blankets or rolls.

A variety of borosilicate glasses can be used in the practice of the methods and materials of the disclosure; it is contemplated that, whatever the boron content of the glass, the infrared radiation absorption, and, as such the insulating power, can be improved by irradiation with an electron beam. For example, in various embodiments of the disclosure, the plurality of borosilicate glass fibers of the borosilicate fiberglass insulation material has a boron content of at least 1 wt %, e.g., at least 2 wt %, on an oxide basis. Glass compositions are quantified herein “on an oxide basis,” which, as the person of ordinary skill in the art will appreciate, treats all metal and semimetal elements present as being in their oxide form, e.g., B₂O₃, Al₂O₃, SiO₂, Na₂O, K₂O, CaO, MgO, and calculating the content of a given metal or semimetal as that oxide. Elements that can have multiple oxidation states are assumed to be in the oxidation state of the material that was used in forming the glass. Thus, a boron content of 5 wt % on an oxide basis means that assuming the metals and semimetals are all in oxide form, the total amount of B₂O₃ is 5 wt %.

In various embodiments of the methods and materials described herein, the plurality of borosilicate glass fibers of the borosilicate fiberglass insulation material has a boron content of at least 3 wt %, e.g., at least 4 wt %, on an oxide basis. In various embodiments, the plurality of borosilicate glass fibers of the borosilicate fiberglass insulation material has a boron content of at least 5 wt %, e.g., at least 6 wt %, on an oxide basis. In various embodiments, the plurality of borosilicate glass fibers of the borosilicate fiberglass insulation material has a boron content of no more than 20 wt %, e.g., no more than 10 wt %, or no more than 8 wt %, on an oxide basis.

For example, in various embodiments, the plurality of borosilicate glass fibers of the borosilicate fiberglass insulation material has a boron content in the range of 1-20 wt %, e.g., 1-10 wt %, or 1-8 wt %, or 2-20 wt %, or 2-10 wt %, or 2-8 wt %, on an oxide basis. In various embodiments, the plurality of borosilicate glass fibers of the borosilicate fiberglass insulation material has a boron content in the range of 3-20 wt %, e.g., 3-10 wt %, or 3-8 wt %, or 4-20 wt %, or 4-10 wt %, or 4-8 wt %, on an oxide basis. In various embodiments, the plurality of borosilicate glass fibers of the borosilicate fiberglass insulation material has a boron content in the range of 5-20 wt %, e.g., 5-10 wt %, or 5-8 wt %, or 6-20 wt %, or 6-10 wt %, or 6-8 wt %, on an oxide basis.

The person of ordinary skill in the art is familiar with borosilicate glass compositions suitable for use in fiberglass insulation materials, and will adapt such compositions for use in the methods and materials described herein. For example, in various embodiments, the plurality of borosilicate glass fibers of the borosilicate fiberglass insulation material has a silicon content of at least 50 wt %, e.g., at least 60 wt %, at least 70 wt %, or at least 80 wt %, on an oxide basis. In various embodiments, the plurality of borosilicate glass fibers of the borosilicate fiberglass insulation material has a silicon content in the range of 50-90 wt %, e.g., 60-90 wt %, or 70-90 wt %, or 80-95 wt %, or 50-80 wt %, or 60-80 wt %, or 70-85 wt %, on an oxide basis. In various embodiments, plurality of borosilicate glass fibers of the borosilicate fiberglass insulation material has an aluminum content up to 20 wt %, e.g., up to 15 wt %, or up to 10 wt %, on an oxide basis. In various embodiments, the plurality of borosilicate glass fibers of the borosilicate fiberglass insulation material has an aluminum content in the range of 0.5-20 wt %, e.g., 0.5-15 wt %, or 0.5-10 wt %, or 1-20 wt %, or 1-15 wt %, or 1-10 wt %, or 2-20 wt %, or 2-15 wt %, or 2-10 wt %, on an oxide basis. In various embodiments, the plurality of borosilicate glass fibers of the borosilicate fiberglass insulation material has a combined calcium and magnesium content of at least 2 wt %, e.g., at least 4 wt %, or at least 6 wt %, on an oxide basis. In various embodiments, the plurality of borosilicate glass fibers of the borosilicate fiberglass insulation material has a combined calcium and magnesium content in the range of 2-20 wt %, e.g., 2-16 wt %, or 2-13 wt %, or 5-20 wt %, or 5-16 wt %, or 5-13 wt %, or 7-20 wt %, or 7-16 wt %, or 7-13 wt %, on an oxide basis. In various embodiments, the plurality of borosilicate glass fibers has a sodium content of at least 5 wt %, e.g., at least 8 wt %, or at least 10 wt %, on an oxide basis. In various embodiments, the plurality of borosilicate glass fibers has a sodium content in the range of 5-25 wt %, e.g., 5-20 wt %, or 5-15 wt %, or 8-25 wt %, or 8-20 wt %, or 8-15 wt %, or 10-25 wt %, or 10-20 wt %, or 10-17 wt %, on an oxide basis. In various embodiments, the plurality of borosilicate fibers has a potassium content up to 2 wt %, e.g., up to 1.5 wt %, or up to 1 wt %, on an oxide basis. In various embodiments, the plurality of borosilicate fibers has a potassium content in the range of 0.1-2 wt %, e.g., 0.1-1.5 wt %, or 0.1-1 wt %, or 0.2-2 wt %, or 0.2-1.5 wt %, or 0.2-1 wt %, or 0.4-2 wt %, or 0.4-1.5 wt %, or 0.4-1 wt %, on an oxide basis. In various embodiments, the plurality of borosilicate fibers are substantially formed of oxides of silicon, boron, aluminum, calcium, magnesium, sodium and potassium. For example, in various embodiments, the plurality of borosilicate fibers has a combined content of sodium, boron, aluminum, calcium, magnesium, sodium and potassium of at least 90 wt %, e.g., at least 95 wt %, or at least 98 wt %, on an oxide basis.

The fibers of the borosilicate fiberglass insulation material are desirably relatively fine, for example, to provide materials that can be installed by blowing to provide a relatively low density, and therefore a relatively high degree of insulation, or to provide a bound insulation material (e.g., in the form of a batt, blanket or roll) with a relatively low density. Thus, in certain embodiments of the methods and materials as otherwise described herein, the median diameter of the plurality of borosilicate glass fibers (i.e., taken for each fiber as the maximum distance across the fiber in a direction perpendicular to the length of the fiber) is no more than about 100 microns, e.g., no more than about 50 microns or even no more than about 20 microns. While relatively fine fibers are desired, in certain embodiments it is desirable for the fibers not to be too thin, so as not to create an inhalation hazard. Accordingly, in certain embodiments as otherwise described herein, the median diameter of the plurality of borosilicate glass fibers is at least 500 nm, e.g., at least 1 micron or at least two microns. The lengths of the fibers will vary, for example, depending on the desired end use of the material. In various embodiments as otherwise described herein, the median length of the plurality of borosilicate glass fibers is no more than 500 mm, e.g., no more than 250 mm, or no more than 100 mm. In various embodiments, the median length of the plurality of borosilicate glass fibers is no more than 50 mm, e.g., no more than 25 mm, or even no more than 10 mm. In other embodiments, the median length of the plurality of borosilicate glass fibers is no more than 5 mm, e.g., no more than 2 mm.

The plurality of borosilicate glass fibers themselves be made using conventional methods, from a variety of borosilicate glass materials. Typically, the glass is formed into fibers from a melt, using any of a number of spinning, centrifugation, drawing, or other fiberizing processes. The fiberizing process itself can provide fibers of a desired length, or fibers can be chopped to a desired size. The resulting hot glass fibers can then be discharged from the fiberization apparatus and allowed to cool as one or more coatings or other treatments are applied thereto; the application of such coatings/treatments can help to cool down the hot mineral fibers. The cooled fibers can be collected, further treated if desired, optionally bound into dusters or into insulation batts, blankets or rolls, and then packaged.

The irradiation with the electron beam can be performed at any convenient time. For example, the insulation with the electron beam can be performed after the formed fibers has substantially cooled. For example, in various embodiments, the plurality of borosilicate glass fibers is at a temperature of no more than 500° C. (e.g., no more than 400° C., no more than 300° C., or no more than 200° C.) when it is irradiated with the electron beam. For example, in various embodiments, the plurality of borosilicate glass fibers is at a temperature in the range of 0-500° C., e.g., 0-400° C., or 0-300° C., or 0-200° C., or 15-500° C., or 15-400° C., or 15-300° C., or 15-200° C., when it is irradiated with the electron beam. This can be convenient from the standpoint of process engineering, for example, with electron beam irradiation taking place relatively remote from the fiberizing process.

But in other embodiments, the plurality of borosilicate glass fibers is at a temperature of at least 200° C. when it is irradiated with the electron beam, e.g., at least 500° C., or at least 700° C., or at least 1000° C. For example, in some embodiments, the temperature of the glass is in range of 200-1500° C., e.g., 500-1500° C., or 700-1500° C., or 1000-1500° C., or 200-1000° C., or 500-1000° C., or 700-1000° C., or 200-500° C., when it is irradiated with the electron beam.

The person of ordinary skill in the art will select electron beam irradiation conditions based on the disclosure herein. For example, in various embodiments, the dose of the electron beam irradiation is at least 250 kGy, for example, at least 500 kGy. In various embodiments, the dose of the electron beam irradiation is at least 750 kGy, e.g., at least 1000 kGy. The present inventors note that an increased effect can be provided with a higher dose. Accordingly, in various embodiments, the dose of electron beam irradiation is at least 5 MGy, e.g., at least 10 MGy, or at least 20 MGy. In various embodiments, the dose of electron beam irradiation is at least 50 MGy, e.g., at least 100 MGy. In various embodiments, the dose of the electron beam irradiation is in the range of 250 kGy-5 GGy, e.g., 250 kGy-2 GGy, or 250 kGy-1 GGy, or 250 kGy-500 MGy, or 250 kGy-100 MGy, or 250 kGy-50 MGy, or 250 kGy-10 MGy, or 250 kGy-5 MGy, or 250 kGy-1 MGy. In various embodiments, the dose of the electron beam irradiation is in the range of 500 kGy-5 GGy, e.g., 500 kGy-2 GGy, or 500 kGy-1 GGy, or 250 kGy-500 MGy, or 500 kGy-100 MGy, or 500 kGy-50 MGy, or 500 kGy-10 MGy, or 500 kGy-5 MGy, or 500 kGy-2 MGy. In various embodiments, the dose of the electron beam irradiation is in the range of 750 kGy-5 GGy, e.g., 750 kGy-2 GGy, or 750 kGy-1 GGy, or 750 kGy-500 MGy, or 750 kGy-100 MGy, or 750 kGy-50 MGy, or 750 kGy-10 MGy, or 750 kGy-5 MGy, or 750 kGy-3 MGy. In various embodiments, the dose of the electron beam irradiation is in the range of 1000 kGy-5 GGy, e.g., 1000 kGy-2 GGy, or 1000 kGy-1 GGy, or 1000 kGy-500 MGy, or 1000 kGy-100 MGy, or 1000 kGy-50 MGy, or 1000 kGy-10 MGy, or 1000 kGy-5 MGy, or 1000 kGy-4 MGy. In various embodiments, the dose of the electron beam irradiation is in the range of 5 MGy-5 GGy, e.g., 5 MGy-2 GGy, or 5 MGy-1 GGy, or 5 MGy-500 MGy, or 5 MGy-100 MGy, or 5 MGy-50 MGy, or 5 MGy-20 MGy. In various embodiments, the dose of the electron beam irradiation is in the range of 10 MGy-5 GGy, e.g., 10 MGy-2 GGy, or 10 MGy-1 GGy, or 10 MGy-500 MGy, or 10 MGy-100 MGy, or 10 MGy-50 MGy, or 10 MGy-30 MGy. In various embodiments, the dose of the electron beam irradiation is in the range of 50 MGy-5 GGy, e.g., 10 MGy-2 GGy, or 10 MGy-1 GGy, or 10 MGy-500 MGy, or 10 MGy-100 MGy, or 10 MGy-50 MGy, or 10 MGy-30 MGy. In various embodiments, the dose of the electron beam irradiation is in the range of 20 MGy-5 GGy, e.g., 20 MGy-2 GGy, or 20 MGy-1 GGy, or 20 MGy-500 MGy, or 20 MGy-100 MGy, or 20 MGy-80 MGy, or 20 MGy-60 MGy. In various embodiments, the dose of the electron beam irradiation is in the range of 50 MGy-5 GGy, e.g., 50 MGy-2 GGy, or 50 MGy-1 GGy, or 50 MGy-500 MGy, or 50 MGy-100 MGy, or 50 MGy-80 MGy. In various embodiments, the dose of the electron beam irradiation is in the range of 100 MGy-5 GGy, e.g., 100 MGy-2 GGy, or 100 MGy-1 GGy, or 100 MGy-500 MGy, or 100 MGy-350 MGy, or 100 MGy-250 MGy.

A variety of electron beam irradiation energies can be used, and the person of ordinary skill in the art, based on the disclosure herein, will determine an appropriate electron beam irradiation for use with a particular material. In various embodiments, the energy of the electron beam irradiation is at least 100 keV, e.g., at least 500 keV. In various embodiments, the energy of the electron beam irradiation is at least 1 MeV, e.g., at least 5 MeV. In various embodiments, the energy of the electron beam irradiation is at least 7.5 MeV, e.g., at least 9 MeV or at least 10 MeV. The person of ordinary skill in the art will appreciate that electron beams of higher energies may desirably be used in some embodiments; irradiation time to provide a desired total dose may be decreased in such cases as compared to irradiation with lower energy electron beams.

As described above, the present inventor has noted that irradiation with electron beam can increase the relative amount of boron in a BO3 configuration. The person of ordinary skill in the art can irradiate the plurality of borosilicate glass fibers to provide a desired degree of increase in proportion of boron in the BO3 configuration. For example, in various embodiments, the irradiation with the electron beam provides the plurality of borosilicate glass fibers with a BO3/BO4 ratio that is greater than a BO3/BO4 ratio of an otherwise identical non-irradiated borosilicate glass fibers by at least 0.02, e.g., at least 0.04, or at least 0.06. For example, in various embodiments, the irradiation with the electron beam provides the plurality of borosilicate glass fibers with a BO3/BO4 ratio that is greater than a BO3/BO4 ratio of an otherwise identical plurality of non-irradiated borosilicate glass fibers by in the range of 0.02-0.20, e.g., in the range of 0.02-0.15, or 0.02-0.10, or 0.04-0.20, or 0.04-0.15, or 0.04-0.10, or 0.06-0.20, or 0.06-0.15, or 0.06-0.10. BO3/BO4 ratios are provided as numerical ratios on an atomic basis, and are determined by boron-11 NMR, using a main field of 20.0 T (¹¹B frequency: 272.8 MHz). Glass materials are powdered and placed in placed in AlN rotors and rotated at a speed of around 18 to 20 kHz in a probe not providing a residual ¹¹B signal. Spectra were acquired using a low-angle pulse (π/12) and a recycling time of 2 times the longest estimated relaxation time (“T1”), which provides equivalent excitement the BO3 and BO4 sites and thus quantitatively comparable signals in the NMR spectra. “Otherwise identical” materials are materials that are treated identically in processing, but lacking the irradiation.

And the present inventors contemplate that higher irradiation dosages can provide even higher changes in the BO3/BO4 ratio. For example, in various embodiments, the irradiation with the electron beam provides the plurality of borosilicate glass fibers with a BO3/BO4 ratio that is greater than a BO3/BO4 ratio of an otherwise identical non-irradiated borosilicate glass fibers by at least 0.1, e.g., at least 0.15, or at least 0.2. In various embodiments, the irradiation with the electron beam provides the plurality of borosilicate glass fibers with a BO3/BO4 ratio that is greater than a BO3/BO4 ratio of an otherwise identical non-irradiated borosilicate glass fibers by at least 0.25, e.g., at least 0.3, or at least 0.35. For example, in various embodiments, the irradiation with the electron beam provides the plurality of borosilicate glass fibers with a BO3/BO4 ratio that is greater than a BO3/BO4 ratio of an otherwise identical non-irradiated borosilicate glass fibers by in the range of 0.1-1, e.g., 0.1-0.7, or 0.1-0.5, or 0.1-0.3, or 0.15-1, or 0.15-0.7, or 0.15-0.6, or 0.15-0.4, or 0.2-1, or 0.2-0.7, or 0.2-0.6, or 0.2-0.5. In various embodiments, the irradiation with the electron beam provides the plurality of borosilicate glass fibers with a BO3/BO4 ratio that is greater than a BO3/BO4 ratio of an otherwise identical non-irradiated borosilicate glass fibers by in the range of 0.25-1, or 0.25-0.7, or 0.25-0.5, or 0.3-1, or 0.3-0.7, or 0.3-0.5, or 0.35-1, or 0.35-0.7 or 0.35-0.5.

It is desirable for the plurality of borosilicate glass fibers of the borosilicate glass insulation material to have a relatively high proportion of boron in the BO3 configuration. In various embodiments of the methods and materials as otherwise described herein, the plurality of borosilicate glass fibers of the borosilicate glass insulation material has a BO3/BO4 ratio of at least 0.60, e.g., at least 0.66, or at least 0.72. In various embodiments, the plurality of borosilicate glass fibers of the borosilicate glass insulation material has a BO3/BO4 ratio in the range of 0.60-1 e.g., 0.60-0.95, or 0.60-0.90, or 0.60-0.85, or 0.66-1, or 0.66-0.95, or 0.66-0.90, or 0.66-0.85, or 0.72-1, or 0.72-0.95, or 0.72-0.90, or 0.72-0.85. In various embodiments, the plurality of the borosilicate glass fibers of the borosilicate glass insulation material has a BO3/BO4 ratio in the range of 0.60-1.22, e.g., 0.60-1.16, or 0.60-1.1, or 0.60-1.0, or 0.66-1.22, or 0.66-1.16, or 0.66-1.1, or 0.72-1.22, or 0.72-1.16, or 0.72-1.1.

In various embodiments of the methods and materials as otherwise described herein, the plurality of borosilicate glass fibers of the borosilicate glass insulation material has a BO3/BO4 ratio of at least 0.77, e.g., at least 0.78, or at least 0.79. In various embodiments, the plurality of borosilicate glass fibers of the borosilicate glass insulation material has a BO3/BO4 ratio of at least 0.80, e.g., at least 0.81, or at least 0.82. In various embodiments, the plurality of borosilicate glass fibers of the borosilicate glass insulation material has a BO3/BO4 ratio in the range of 0.77-1 e.g., 0.77-0.95, or 0.77-0.90, or 0.77-0.85, or 0.78-1, or 0.78-0.95, or 0.78-0.90, or 0.78-0.85, or 0.79-1, or 0.79-0.95, or 0.79-0.90, or 0.79-0.85. In various embodiments, the plurality of borosilicate glass fibers of the borosilicate glass insulation material has a BO3/BO4 ratio in the range of 0.80-1 e.g., 0.80-0.95, or 0.80-0.90, or 0.80-0.85, or 0.81-1, or 0.81-0.95, or 0.81-0.90, or 0.81-0.86, or 0.82-1, or 0.82-0.95, or 0.82-0.90, or 0.82-0.87.

Here, too, the present inventors contemplate that higher irradiation dosages can provide even higher BO3/BO4 ratios. For example, in some embodiments, the plurality of the borosilicate glass fibers of the borosilicate glass insulation material has a BO3/BO4 ratio of at least 0.85, e.g., at least 0.90, or at least 0.95. In some embodiments, the plurality of the borosilicate glass fibers of the borosilicate glass insulation material has a BO3/BO4 ratio of at least 1.00, e.g., at least 1.05, or at least 1.10. In various embodiments, the plurality of the borosilicate glass fibers of the borosilicate glass insulation material has a BO3/BO4 ratio in the range of 0.85-1.22, e.g., 0.85-1.16, or 0.85-1.1, or 0.85-1.0, or 0.90-1.22, or 0.90-1.16, or 0.90-1.1, or 0.95-1.22, or 0.95-1.16, or 0.95-1.1. In various embodiments, the plurality of the borosilicate glass fibers of the borosilicate glass insulation material has a BO3/BO4 ratio in the range of 1.00-1.22, e.g., 1.00-1.16, or 1.00-1.1, or 1.05-1.22, or 1.05-1.16, or 1.05-1.12, or 1.10-1.22 or 1.10-1.18 or 1.10-1.14.

The present inventor has noted that the thermal conductivity of an insulation material can be decreased by electron beam irradiation. In various embodiments of the materials and methods as otherwise described herein, the irradiation with the electron beam provides the borosilicate fiberglass insulation material with a thermal conductivity that is at least 4% less than, e.g., at least 6% less than, or at least 8% less than, or at least 10% less than, a thermal conductivity of an otherwise borosilicate fiberglass insulation material comprising an otherwise identical plurality of non-irradiated borosilicate glass fibers. For example, in various embodiments, wherein the irradiation with the electron beam provides the borosilicate fiberglass insulation material with a thermal conductivity that is in the range of 4-25% less than, e.g., in the range of 4-20% less than, or 4-12% less than, or 6-25% less than, or 6-20% less than, or 6-15% less than, 8-25% less than or 8-20% less than, or 8-15% less than, a thermal conductivity of an otherwise borosilicate fiberglass insulation material comprising an otherwise identical plurality of non-irradiated borosilicate glass fibers.

In various embodiments, the e-beam irradiation of the glass fibers provides the insulation material with an improvement in N′ value as compared to an otherwise identical non-irradiated material, i.e., normalized for density. N′ is defined by the equation

$${N}^{′} = \frac{1}{ρ d} ( 1 - \frac{2}{ε} + \frac{1.050 d}{k - a - b ρ} )$$

in which ρ is density (in lb/ft³), d is thickness (in inches), ε is emissivity, k is thermal conductivity (measured in BTU·in per hr·ft²·° F.), a is 0.17956 BTU-in per hr·ft²·° F., and b is 0.005 BTU·in·ft³ per hr·ft²·° F.·lb).

For example, in various embodiments, the e-beam irradiation of the glass fibers provides the insulation material with an N′ value that is at least 0.5 greater than, e.g., at least 1 greater than, or at least 1.5 greater than, or at least 2 greater than, or at least 3 greater than the N′ value of an otherwise insulation material comprising an otherwise identical plurality of non-irradiated borosilicate glass fibers. In various embodiments, the e-beam irradiation of the glass fibers provides the insulation material with an N′ value that is in the range of 0.5-10 greater than the N′ value of an otherwise insulation material comprising an otherwise identical plurality of non-irradiated borosilicate glass fibers, e.g., in the range of 1-10, or 1.5-10, or 2-10, or 0.5-7, or 1-7, or 1.5-7, or 2-7, or 0.5-5, or 1-5.5, or 1.5-6.

In various embodiments of the methods and materials as otherwise described herein, the plurality of borosilicate fibers is coated with a silicone. As the person of ordinary skill in the art will appreciate, fiberglass insulation materials are conventionally coated with a silicone in order to improve inter-fiber lubricity and provide the fibers with hydrophobic surfaces to help prevent moisture absorption by the material and to protect the fibers from hydrolytic attack. Conventionally, this coating is performed using an aqueous emulsion of a silicone, applied while the fibrous material is still hot from being spun or drawn from bulk material. Oil and/or an antistatic additive may also or alternatively be coated on the glass fibers.

In various embodiments of the methods and materials as described herein, the borosilicate fiberglass insulation material is formed as a loose-fill borosilicate fiberglass material. Such a material can be provided as relatively short fibers, suitable for installation using conventional loose-fill installation methods, e.g., by being blown through a hose for disposition against an interior surface of a building. The material can be an unbound loose-fill borosilicate fiberglass material, in which the plurality of borosilicate glass fibers is not bound with a polymer binder. In other embodiments, the plurality of borosilicate glass fibers is bound with a polymer binder, e.g., into clusters of loose-fill borosilicate fiberglass material.

The loose-fill borosilicate fiberglass insulation materials described herein can be packaged, e.g., by being compressed and packaged, e.g., into bags or other sealed containers.

In other embodiments, the borosilicate fiberglass insulation materials of the disclosure are provided as bound borosilicate fiberglass insulation materials, further comprising a polymer binder binding the plurality of borosilicate glass fibers. As the person of ordinary skill in the art will appreciate, such materials can be provided in any of a number of forms, for example, in the form of an insulation batt, blanket or roll.

Another aspect of the disclosure is a borosilicate fiberglass insulation material made by a process as described herein.

Another aspect of the disclosure is a borosilicate fiberglass insulation material comprising a plurality of electron beam-irradiated borosilicate glass fibers. The borosilicate fiberglass insulation material can otherwise be substantially as described above with respect to the methods described above. And, in various embodiments, the borosilicate fiberglass insulation material according to this aspect of the disclosure can be made by a method as described herein.

Another aspect of the disclosure is a borosilicate fiberglass insulation material comprising a plurality of electron beam-irradiated borosilicate glass fibers. The borosilicate fiberglass insulation material can otherwise be substantially as described above. And, in various embodiments, the borosilicate fiberglass insulation material according to this aspect of the disclosure can be made by a method as described herein.

Another aspect of the disclosure is a borosilicate fiberglass insulation material comprising a plurality of borosilicate glass fibers having a BO3/BO4 ratio of at least 0.77, e.g., at least 0.78, or at least 0.79. The borosilicate fiberglass insulation material can otherwise be substantially as described above. And, in various embodiments, the borosilicate fiberglass insulation material according to this aspect of the disclosure can be made by a method as described herein.

The borosilicate fiberglass insulation materials described herein can be provided with a variety of densities, depending on the desired end use. For example, the borosilicate fiberglass insulation materials can in some embodiments of the methods and materials as otherwise described herein be provided with densities in the range of 0.1-20 lb/ft³. In various embodiments, the borosilicate fiberglass insulation material has a density in the range of 0.25-8 lb/ft³ (e.g., with the borosilicate fiberglass insulation material being a glass wool); or 0.25-2 lb/ft³ (e.g., with the mineral wool being in the form of a flexible building insulation material); or 0.25-0.75 lb/ft³ (e.g., with the borosilicate fiberglass insulation material being in the form of a flexible highly compressible building insulations); or 0.25-0.510 lb/ft³ (e.g., with the borosilicate fiberglass insulation material being in the form of a loose-fill insulation).

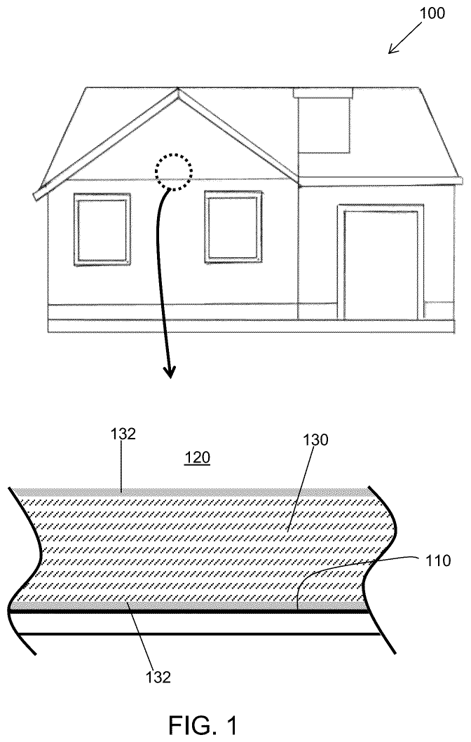

The borosilicate fiberglass insulation material described herein can advantageously be used as insulation materials in a variety of contexts, including insulation of building structures. Accordingly, another aspect of the disclosure is an insulated structure, the insulated structure having an interior surface (e.g., a surface of a wall, a ceiling, floor, an attic, a basement, or another building surface), and a borosilicate fiberglass insulation material as described herein disposed against the interior surface. One such embodiment is shown in FIG. 1. Here, the insulated structure is house 100, of which an attic section is shown in detail. The interior surface is a ceiling surface 110 facing an attic 120, with a borosilicate fiberglass insulation material 130 as described herein disposed against the interior surface. There can be one or more layers of liner between the borosilicate fiberglass insulation material and the interior surface. For example, in this embodiment the borosilicate fiberglass insulation material is in the form of an insulation batt, with liners 132 (e.g., formed from paper) encasing the borosilicate fiberglass insulation material.

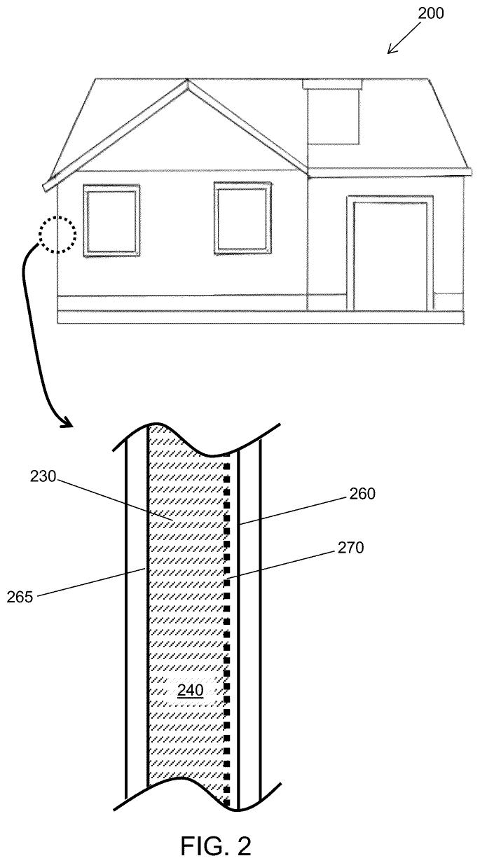

For example, loose-fill materials as described herein can be used in so-called “blow-in-blanket” applications, in which a netting or other fabric encloses a cavity (e.g., in between wall studs) and a loose-fill insulation borosilicate fiberglass insulation material is disposed in the enclosed cavity. Such an embodiment is shown in FIG. 2, in which an exterior wall structure of house 200 is shown in detail. Here, fabric 270 encloses a cavity 340 partially defined by exterior surface 265 (here, a surface of a sheathing). Loose-fill borosilicate fiberglass insulation material 230 as described herein is disposed in the cavity defined by the fabric. Loose-fill materials can also advantageously be used in so-called “open-blow” applications, for example in which a loose-fill material is disposed loosely on an attic floor or above a ceiling of a structure (e.g. along an upward-facing surface, such as that described above with respect to FIG. 1).

Another aspect of the disclosure is an insulated structure (e.g., a building) having an interior surface and an exterior surface, and a borosilicate fiberglass insulation material as described herein disposed in and at least partially filling a cavity between the interior surface and the exterior surface. The cavity can be, e.g., in a wall of the structure, a ceiling of the structure, or a floor of the structure. Such a structure is shown in FIG. 2, with the cavity being defined by the interior surface 260 (here, the surface of a wallboard) and the exterior surface 265. In certain such embodiments, the cavity is substantially (e.g., at least 90 vol %) filled by the borosilicate fiberglass insulation material described herein. And another aspect of the disclosure is an insulated cavity having a first surface and a second surface, and a borosilicate fiberglass insulation material as described herein disposed in between the first surface and the second surface.

Thus, the borosilicate fiberglass insulation materials described herein can be used in insulating a variety of structures by being disposed in a cavity therein.

As a proof of concept experiment, the present inventor has irradiated a polymer-bound borosilicate fiberglass insulation material (in the form of an insulation batt) with an electron beam (S-band, 10 MeV, 15 kW, L3 Pulse Sciences system, distance from beam window to material ˜30″), with a first set of irradiations being performed over a first three-day period at a total first dose measured as 525 kGy by a dosimeter at the top of the sample and 505 kGy by a dosimeter at the bottom of the sample; and a second set of irradiations being performed 46 days later over a second two-day period to provide a cumulative total dosage measured as 1045 kGy by a dosimeter at the top of the sample and 1007 kGy by a dosimeter at the bottom of the sample. A control batt from the same batch of material was stored in a plastic bag.

It is noted that the control and sample materials were in the form of insulation batts, with borosilicate glass fibers bound by a polymer binder. The sample material was observed to char somewhat during e-beam irradiation; it is believed that the binder decomposed under e-beam irradiation, which resulted in a significant increase in density of the batt. The control batt was not irradiated with an electron beam, but was compressed somewhat due to handling during the about six months of storage during which the irradiation experiments were being designed and conducted. These effects are believed to be experimental artifacts, as in typical performance of the methods and materials described herein, the e-beam irradiation would be performed in the absence of binder.

The materials of the control batt and the sample batt were analyzed by boron-11 NMR to determine the BO3/BO4 ratio using the conditions described herein. The BO3/BO4 ratio of the control batt was 0.745 after six months of storage, while the BO3/BO4 ratio of the sample batt was 0.792. This is a significant increase, and the present inventors note that even higher increases in ratios of BO3/BO4 can be achieved with higher doses of electron beam irradiation.

Various aspects of the disclosure are provided by the following enumerated embodiments, which can be combined in any number and in any combination that is not logically or technically inconsistent.

Embodiment 1. A method for making a borosilicate fiberglass insulation material comprising a plurality of borosilicate glass fibers, the method comprising:
providing a borosilicate fiberglass comprising a plurality of borosilicate glass fibers; and
irradiating the plurality of borosilicate glass fibers of the borosilicate fiberglass with an electron beam.

Embodiment 2. The method according to embodiment 1, wherein the plurality of borosilicate glass fibers of the borosilicate fiberglass insulation material has a boron content of at least 1 wt %, e.g., at least 2 wt %, on an oxide basis.

Embodiment 3. The method according to embodiment 1, wherein the plurality of borosilicate glass fibers of the borosilicate fiberglass insulation material has a boron content of at least 3 wt %, e.g., at least 4 wt %, on an oxide basis.

Embodiment 4. The method according to embodiment 1, wherein the plurality of borosilicate glass fibers of the borosilicate fiberglass insulation material has a boron content of at least 5 wt %, e.g., at least 6 wt %, on an oxide basis.

Embodiment 5. The method according to any of embodiments 1-4, wherein the plurality of borosilicate glass fibers of the borosilicate fiberglass insulation material has a boron content of no more than 20 wt %, e.g., no more than 10 wt %, or no more than 8 wt %, on an oxide basis.

Embodiment 6. The method according to embodiment 1, wherein the plurality of borosilicate glass fibers of the borosilicate fiberglass insulation material has a boron content in the range of 1-20 wt %, e.g., 1-10 wt %, or 1-8 wt %, or 2-20 wt %, or 2-10 wt %, or 2-8 wt %, on an oxide basis.

Embodiment 7. The method according to embodiment 1, wherein the plurality of borosilicate glass fibers of the borosilicate fiberglass insulation material has a boron content in the range of 3-20 wt %, e.g., 3-10 wt %, or 3-8 wt %, or 4-20 wt %, or 4-10 wt %, or 4-8 wt %, on an oxide basis.

Embodiment 8. The method according to embodiment 1, wherein the plurality of borosilicate glass fibers of the borosilicate fiberglass insulation material has a boron content in the range of 5-20 wt %, e.g., 5-10 wt %, or 5-8 wt %, or 6-20 wt %, or 6-10 wt %, or 6-8 wt %, on an oxide basis.

Embodiment 9. The method according to any of embodiments 1-8, wherein the plurality of borosilicate glass fibers of the borosilicate fiberglass insulation material has a silicon content of at least 50 wt %, e.g., at least 60 wt %, at least 70 wt %, or at least 80 wt %, on an oxide basis.

Embodiment 10. The method according to any of embodiments 1-8, wherein the plurality of borosilicate glass fibers of the borosilicate fiberglass insulation material has a silicon content in the range of 50-90 wt %, e.g., 60-90 wt %, or 70-90 wt %, or 80-95 wt %, or 50-80 wt %, or 60-80 wt %, or 70-85 wt %, on an oxide basis.

Embodiment 11. The method according to any of embodiments 1-10, wherein the plurality of borosilicate glass fibers of the borosilicate fiberglass insulation material has an aluminum content up to 20 wt %, e.g., up to 15 wt %, or up to 10 wt %, on an oxide basis.

Embodiment 12. The method according to any of embodiments 1-10, wherein the plurality of borosilicate glass fibers of the borosilicate fiberglass insulation material has an aluminum content in the range of 0.5-20 wt %, e.g., 0.5-15 wt %, or 0.5-10 wt %, or 1-20 wt %, or 1-15 wt %, or 1-10 wt %, or 2-20 wt %, or 2-15 wt %, or 2-10 wt %, on an oxide basis.

Embodiment 13. The method according to any of embodiments 1-12, wherein the plurality of borosilicate glass fibers of the borosilicate fiberglass insulation material has a combined calcium and magnesium content of at least 2 wt %, e.g., at least 4 wt %, or at least 6 wt %, on an oxide basis.

Embodiment 14. The method according to any of embodiments 1-12, wherein the plurality of borosilicate glass fibers of the borosilicate fiberglass insulation material has a combined calcium and magnesium content in the range of 2-20 wt %, e.g., 2-16 wt %, or 2-13 wt %, or 5-20 wt %, or 5-16 wt %, or 5-13 wt %, or 7-20 wt %, or 7-16 wt %, or 7-13 wt %, on an oxide basis.

Embodiment 15. The method according to any of embodiments 1-14, wherein the plurality of borosilicate glass fibers of the borosilicate fiberglass insulation material has a sodium content of at least 5 wt %, e.g., at least 8 wt %, or at least 10 wt %, on an oxide basis.

Embodiment 16. The method according to any of embodiments 1-14, wherein the plurality of borosilicate glass fibers of the borosilicate fiberglass insulation material has a sodium content in the range of 5-25 wt %, e.g., 5-20 wt %, or 5-15 wt %, or 8-25 wt %, or 8-20 wt %, or 8-15 wt %, or 10-25 wt %, or 10-20 wt %, or 10-17 wt %, on an oxide basis.

Embodiment 17. The method according to any of embodiments 1-16, wherein the plurality of borosilicate glass fibers of the borosilicate fiberglass insulation material has a potassium content up to 2 wt %, e.g., up to 1.5 wt %, or up to 1 wt %, on an oxide basis.

Embodiment 18. The method according to any of embodiments 1-16, wherein the plurality of borosilicate glass fibers of the borosilicate fiberglass insulation material has a potassium content in the range of 0.1-2 wt %, e.g., 0.1-1.5 wt %, or 0.1-1 wt %, or 0.2-2 wt %, or 0.2-1.5 wt %, or 0.2-1 wt %, or 0.4-2 wt %, or 0.4-1.5 wt %, or 0.4-1 wt %, on an oxide basis.

Embodiment 19. The method according to any of embodiments 1-18, wherein the plurality of borosilicate glass fibers of the borosilicate fiberglass insulation material has a combined content of sodium, boron, aluminum, calcium, magnesium, sodium and potassium of at least 90 wt %, e.g., at least 95 wt %, or at least 98 wt %, on an oxide basis.

Embodiment 20. The method according to any of embodiments 1-19, wherein the median diameter of the plurality of borosilicate glass fibers (i.e., for each fiber, taken as the maximum distance across the fiber in a direction perpendicular to the length of the fiber) is no more than about 100 microns, e.g., no more than about 50 microns or even no more than about 20 microns.

Embodiment 21. The method according to any of embodiments 1-20, wherein the median length of the plurality of borosilicate glass fibers is no more than 500 mm, e.g., no more than 250 mm, or no more than 100 mm.

Embodiment 22. The method according to any of embodiments 1-20, wherein the median length of the plurality of borosilicate glass fibers is no more than 50 mm, e.g., no more than 25 mm, or even no more than 10 mm.

Embodiment 23. The method according to any of embodiments 1-20, wherein the median length of the plurality of borosilicate glass fibers is no more than 5 mm, e.g., no more than 2 mm.

Embodiment 24. The method according to any of embodiments 1-23, wherein the plurality of borosilicate glass fibers is at a temperature of no more than 500° C. (e.g., no more than 400° C., no more than 300° C., or no more than 200° C.) when it is irradiated with the electron beam.

Embodiment 25. The method according to any of embodiments 1-23, wherein the plurality of borosilicate glass fibers is at a temperature in the range of 0-500° C., e.g., 0-400° C., or 0-300° C., or 0-200° C., or 15-500° C., or 15-400° C., or 15-300° C., or 15-200° C., when it is irradiated with the electron beam.

Embodiment 26. The method according to any of embodiments 1-25, wherein the plurality of borosilicate glass fibers is at a temperature of at least 200° C. when it is irradiated with the electron beam, e.g., at least 500° C., or at least 700° C., or at least 1000° C., when it is irradiated with the electron beam.

Embodiment 27. The method according to any of embodiments 1-25, wherein the plurality of borosilicate glass fibers is at a temperature in the range of 200-1500° C., e.g., 500-1500° C., or 700-1500° C., or 1000-1500° C., or 200-1000° C., or 500-1000° C., or 700-1000° C., or 200-500° C., when it is irradiated with the electron beam.

Embodiment 28. The method according to any of embodiments 1-27, wherein the dose of the electron beam is at least 250 kGy, for example, at least 500 kGy.

Embodiment 29. The method according to any of embodiments 1-27, wherein the dose of the electron beam irradiation is at least 750 kGy, e.g., at least 1000 kGy.

Embodiment 30. The method according to any of embodiments 1-27, wherein the dose of electron beam irradiation is at least 5 MGy, e.g., at least 10 MGy, or at least 20 MGy.

Embodiment 31. The method according to any of embodiments 1-27, wherein the dose of electron beam irradiation is at least 50 MGy, e.g., at least 100 MGy.

Embodiment 32. The method according to any of embodiments 1-27, wherein the dose of the electron beam irradiation is in the range of 250 kGy-5 GGy, e.g., 250 kGy-2 GGy, or 250 kGy-1 GGy, or 250 kGy-500 MGy, or 250 kGy-100 MGy, or 250 kGy-50 MGy, or 250 kGy-10 MGy, or 250 kGy-5 MGy, or 250 kGy-1 MGy.

Embodiment 33. The method according to any of embodiments 1-27, wherein the dose of the electron beam irradiation is in the range of 500 kGy-5 GGy, e.g., 500 kGy-2 GGy, or 500 kGy-1 GGy, or 250 kGy-500 MGy, or 500 kGy-100 MGy, or 500 kGy-50 MGy, or 500 kGy-10 MGy, or 500 kGy-5 MGy, or 500 kGy-2 MGy.

Embodiment 34. The method according to any of embodiments 1-27, wherein the dose of the electron beam irradiation is in the range of 750 kGy-5 GGy, e.g., 750 kGy-2 GGy, or 750 kGy-1 GGy, or 750 kGy-500 MGy, or 750 kGy-100 MGy, or 750 kGy-50 MGy, or 750 kGy-10 MGy, or 750 kGy-5 MGy, or 750 kGy-3 MGy.

Embodiment 35. The method according to any of embodiments 1-27, wherein the dose of the electron beam irradiation is in the range of 1000 kGy-5 GGy, e.g., 1000 kGy-2 GGy, or 1000 kGy-1 GGy, or 1000 kGy-500 MGy, or 1000 kGy-100 MGy, or 1000 kGy-50 MGy, or 1000 kGy-10 MGy, or 1000 kGy-5 MGy, or 1000 kGy-4 MGy.

Embodiment 36. The method according to any of embodiments 1-27, wherein the dose of the electron beam irradiation is in the range of 5 MGy-5 GGy, e.g., 5 MGy-2 GGy, or 5 MGy-1 GGy, or 5 MGy-500 MGy, or 5 MGy-100 MGy, or 5 MGy-50 MGy, or 5 MGy-20 MGy.

Embodiment 37. The method according to any of embodiments 1-27, wherein the dose of the electron beam irradiation is in the range of 10 MGy-5 GGy, e.g., 10 MGy-2 GGy, or 10 MGy-1 GGy, or 10 MGy-500 MGy, or 10 MGy-100 MGy, or 10 MGy-50 MGy, or 10 MGy-30 MGy.

Embodiment 38. The method according to any of embodiments 1-27, wherein the dose of the electron beam irradiation is in the range of 50 MGy-5 GGy, e.g., 10 MGy-2 GGy, or 10 MGy-1 GGy, or 10 MGy-500 MGy, or 10 MGy-100 MGy, or 10 MGy-50 MGy, or 10 MGy-30 MGy.

Embodiment 39. The method according to any of embodiments 1-27, wherein the dose of the electron beam irradiation is in the range of 20 MGy-5 GGy, e.g., 20 MGy-2 GGy, or 20 MGy-1 GGy, or 20 MGy-500

Embodiment 40. The method according to any of embodiments 1-27, wherein various embodiments, the dose of the electron beam irradiation is in the range of 50 MGy-5 GGy, e.g., 50 MGy-2 GGy, or 50 MGy-1 GGy, or 50 MGy-500 MGy, or 50 MGy-100 MGy, or 50 MGy-80 MGy.

Embodiment 41. The method according to any of embodiments 1-27, wherein the dose of the electron beam irradiation is in the range of 100 MGy-5 GGy, e.g., 100 MGy-2 GGy, or 100 MGy-1 GGy, or 100 MGy-500 MGy, or 100 MGy-350 MGy, or 100 MGy-250 MGy.

Embodiment 42. The method according to any of embodiments 1-41, wherein the energy of the electron beam irradiation is at least 100 keV, e.g., at least 500 keV, for example, at least 1 MeV, e.g., at least 5 MeV.

Embodiment 43. The method according to any of embodiments 1-41, wherein the energy of the electron beam irradiation is at least 7.5 MeV, e.g., at least 9 MeV or at least 10 MeV.

Embodiment 44. The method according to any of embodiments 1-43, wherein the irradiation with the electron beam provides the plurality of borosilicate glass fibers with a BO3/BO4 ratio that is greater than a BO3/BO4 ratio of an otherwise identical non-irradiated borosilicate glass fibers by at least 0.02, e.g., at least 0.04, or at least 0.06.

Embodiment 45. The method according to any of embodiments 1-43, wherein the irradiation with the electron beam provides the plurality of borosilicate glass fibers with a BO3/BO4 ratio that is greater than a BO3/BO4 ratio of an otherwise identical plurality of non-irradiated borosilicate glass fibers by in the range of 0.02-0.20, e.g., in the range of 0.02-0.15, or 0.02-0.10, or 0.04-0.20, or 0.04-0.15, or 0.04-0.10, or 0.06-0.20, or 0.06-0.15, or 0.06-0.10.

Embodiment 46. The method according to any of embodiments 1-43, wherein the irradiation with the electron beam provides the plurality of borosilicate glass fibers with a BO3/BO4 ratio that is greater than a BO3/BO4 ratio of an otherwise identical non-irradiated borosilicate glass fibers by at least 0.1, e.g., at least 0.15, or at least 0.2.

Embodiment 47. The method according to any of embodiments 1-43, wherein the irradiation with the electron beam provides the plurality of borosilicate glass fibers with a BO3/BO4 ratio that is greater than a BO3/BO4 ratio of an otherwise identical non-irradiated borosilicate glass fibers by at least 0.25, e.g., at least 0.3, or at least 0.35.

Embodiment 48. The method according to any of embodiments 1-43, wherein the irradiation with the electron beam provides the plurality of borosilicate glass fibers with a BO3/BO4 ratio that is greater than a BO3/BO4 ratio of an otherwise identical plurality of non-irradiated borosilicate glass fibers by in the range of 0.1-1, e.g., 0.1-0.7, or 0.1-0.5, or 0.1-0.3, or 0.15-1, or 0.15-0.7, or 0.15-0.6, or 0.15-0.4, or 0.2-1, or 0.2-0.7, or 0.2-0.6, or 0.2-0.5.

Embodiment 49. The method according to any of embodiments 1-43, wherein the irradiation with the electron beam provides the plurality of borosilicate glass fibers with a BO3/BO4 ratio that is greater than a BO3/BO4 ratio of an otherwise identical plurality of non-irradiated borosilicate glass fibers by in the range of 0.25-1, or 0.25-0.7, or 0.25-0.5, or 0.3-1, or 0.3-0.7, or 0.3-0.5, or 0.35-1, or 0.35-0.7 or 0.35-0.5.

Embodiment 50. The method according to any of embodiments 1-49, wherein the plurality of borosilicate glass fibers of the borosilicate glass insulation material has a BO3/BO4 ratio of at least 0.60, e.g., at least 0.66, or at least 0.72.

Embodiment 51. The method according to any of embodiments 1-49, wherein the plurality of borosilicate glass fibers of the borosilicate glass insulation material has a BO3/BO4 ratio in the range of 0.60-1 e.g., 0.60-0.95, or 0.60-0.90, or 0.60-0.85, or 0.66-1, or 0.66-0.95, or 0.66-0.90, or 0.66-0.85, or 0.72-1, or 0.72-0.95, or 0.72-0.90, or 0.72-0.85.

Embodiment 52. The method according to any of embodiments 1-49, wherein the plurality of the borosilicate glass fibers of the borosilicate glass insulation material has a BO3/BO4 ratio in the range of 0.60-1.22, e.g., 0.60-1.16, or 0.60-1.1, or 0.60-1.0, or 0.66-1.22, or 0.66-1.16, or 0.66-1.1, or 0.72-1.22, or 0.72-1.16, or 0.72-

Embodiment 53. The method according to any of embodiments 1-49, wherein the plurality of borosilicate glass fibers of the borosilicate glass insulation material has a BO3/BO4 ratio of at least 0.77, e.g., at least 0.78, or at least 0.79.

Embodiment 54. The method according to any of embodiments 1-49, wherein the plurality of borosilicate glass fibers of the borosilicate glass insulation material has a BO3/BO4 ratio of at least 0.80, e.g., at least 0.81, or at least 0.82.

Embodiment 55. The method according to any of embodiments 1-49, wherein the plurality of borosilicate glass fibers of the borosilicate glass insulation material has a BO3/BO4 ratio in the range of 0.77-1 e.g., 0.77-0.95, or 0.77-0.90, or 0.77-0.85, or 0.78-1, or 0.78-0.95, or 0.78-0.90, or 0.78-0.85, or 0.79-1, or 0.79-0.95, or 0.79-0.90, or 0.79-0.85.

Embodiment 56. The method according to any of embodiments 1-49, wherein the plurality of borosilicate glass fibers of the borosilicate glass insulation material has a BO3/BO4 ratio in the range of 0.80-1 e.g., 0.80-0.95, or 0.80-0.90, or 0.80-0.85, or 0.81-1, or 0.81-0.95, or 0.81-0.90, or 0.81-0.86, or 0.82-1, or 0.82-0.95, or 0.82-0.90, or 0.82-0.87.

Embodiment 57. The method according to any of embodiments 1-49, wherein the plurality of the borosilicate glass fibers of the borosilicate glass insulation material has a BO3/BO4 ratio of at least 0.85, e.g., at least 0.90, or at least 0.95.

Embodiment 58. The method according to any of embodiments 1-49, wherein the plurality of the borosilicate glass fibers of the borosilicate glass insulation material has a BO3/BO4 ratio of at least 1.00, e.g., at least 1.05, or at least 1.10.

Embodiment 59. The method according to any of embodiments 1-49, wherein the plurality of the borosilicate glass fibers of the borosilicate glass insulation material has a BO3/BO4 ratio in the range of 0.85-1.22, e.g., 0.85-1.16, or 0.85-1.1, or 0.85-1.0, or 0.90-1.22, or 0.90-1.16, or 0.90-1.1, or 0.95-1.22, or 0.95-1.16, or 0.95-1.1.

Embodiment 60. The method according to any of embodiments 1-49, wherein the plurality of the borosilicate glass fibers of the borosilicate glass insulation material has a BO3/BO4 ratio in the range of 1.00-1.22, e.g., 1.00-1.16, or 1.00-1.1, or 1.05-1.22, or 1.05-1.16, or 1.05-1.12, or 1.10-1.22 or 1.10-1.18 or 1.10-1.14.

Embodiment 61. The method according to any of embodiments 1-60, wherein the irradiation with the electron beam provides the borosilicate fiberglass insulation material with a thermal conductivity that is at least 4% less than, e.g., at least 6% less than, or at least 8% less than, or at least 10% less than, a thermal conductivity of an otherwise borosilicate fiberglass insulation material comprising an otherwise identical plurality of non-irradiated borosilicate glass fibers.

Embodiment 62. The method according to any of embodiments 1-60, wherein the irradiation with the electron beam provides the borosilicate fiberglass insulation material with a thermal conductivity that is in the range of 4-25% less than, e.g., in the range of 4-20% less than, or 4-12% less than, or 6-25% less than, or 6-20% less than, or 6-15% less than, 8-25% less than or 8-20% less than, or 8-15% less than, a thermal conductivity of an otherwise borosilicate fiberglass insulation material comprising an otherwise identical plurality of non-irradiated borosilicate glass fibers.

Embodiment 63. The method according to any of embodiments 1-62, wherein the e-beam irradiation of the glass fibers provides the insulation material with an improvement in N′ value as compared to an otherwise identical non-irradiated material, i.e., normalized for density.

Embodiment 64. The method according to any of embodiments 1-52, wherein the e-beam irradiation of the glass fibers provides the insulation material with an N′ value that is at least 0.5 greater than, e.g., at least 1 greater than, or at least 1.5 greater than, or at least 2 greater than, or at least 3 greater than the N′ value of an otherwise insulation material comprising an otherwise identical plurality of non-irradiated borosilicate glass fibers.

Embodiment 65. The method according to any of embodiments 1-52, wherein the e-beam irradiation of the glass fibers provides the insulation material with an N′ value that is in the range of 0.5-10 greater than the N′ value of an otherwise insulation material comprising an otherwise identical plurality of non-irradiated borosilicate glass fibers, e.g., greater than the N′ value of an otherwise insulation material comprising an otherwise identical plurality of non-irradiated borosilicate glass fibers by an amount in the range of 1-10, or 1.5-10, or 2-10, or 0.5-7, or 1-7, or 1.5-7, or 2-7, or 0.5-5, or 1-5.5, or 1.5-6.

Embodiment 66. The method according to any of embodiments 1-65, further comprising coating the plurality of borosilicate fibers with a silicone.

Embodiment 67. The method according to embodiment 66, wherein the coating with the silicone is performed before the electron beam irradiation.

Embodiment 68. The method according to embodiment 66, wherein the coating with the silicone is performed after the electron beam irradiation.

Embodiment 69. The method according to any of embodiments 1-68, wherein the borosilicate fiberglass insulation material is formed as a loose-fill borosilicate fiberglass insulation material.

Embodiment 70. The method according to embodiment 69, wherein the borosilicate fiberglass insulation material is formed as an unbound loose-fill borosilicate fiberglass insulation material.

Embodiment 71. The method according to embodiment 69, wherein the borosilicate fiberglass insulation material includes a polymer binder binding the plurality of borosilicate glass fibers.

Embodiment 72. The method according to embodiment 71, further comprising applying a binder to the plurality of borosilicate glass fibers (e.g., after irradiation with the electron beam).

Embodiment 73. The method according to any of embodiments 69-72, further comprising compressing the borosilicate fiberglass insulation material and packaging it in a sealed container.

Embodiment 74. The method according to any of embodiments 1-69, 72 and 73, wherein the borosilicate fiberglass insulation material is formed as a bound borosilicate fiberglass insulation material and further includes a polymer binder binding the plurality of borosilicate glass fibers.

Embodiment 75. The method according to embodiment 74, wherein the borosilicate fiberglass insulation material is in the form of an insulation batt, blanket or roll.

Embodiment 76. A borosilicate fiberglass insulation material made by a method according to any of embodiments 1-75.

Embodiment 77. A borosilicate fiberglass insulation material comprising a plurality of electron beam-irradiated borosilicate glass fibers.

Embodiment 78. A borosilicate fiberglass insulation material according to embodiment 77, wherein the plurality of borosilicate glass fibers of the borosilicate glass insulation material has a BO3/BO4 ratio as described in any of embodiments 50-60.

Embodiment 79. The borosilicate fiberglass insulation material according to embodiment 77 or embodiment 78, made by a method according to any of embodiments 1-75.

Embodiment 80. The borosilicate fiberglass insulation material or method of making same according to any of embodiments 1-79, wherein the borosilicate fiberglass insulation material has a density in the range of 0.1-20 lb/ft³.

Embodiment 81. The borosilicate fiberglass insulation material or method of making same according to any of embodiments 1-79, wherein the borosilicate fiberglass insulation material has a density in the range of 0.25-8 lb/ft³ (e.g., with the borosilicate fiberglass insulation material being a glass wool); or 0.25-2 lb/ft³ (e.g., with the mineral wool being in the form of a flexible building insulation material); or 0.25-0.75 lb/ft³ (e.g., with the borosilicate fiberglass insulation material being in the form of a flexible highly compressible building insulations); or 0.25-0.50 lb/ft³ (e.g., with the borosilicate fiberglass insulation material being in the form of a loose-fill insulation).

Embodiment 82. An insulated structure having an interior surface (e.g., a surface of a wall, a ceiling, floor, an attic, a basement, or another building surface), and a borosilicate fiberglass insulation material according to any of embodiments 76-81 disposed against the interior surface.

Embodiment 83. The insulated structure according to embodiment 82, wherein the interior surface is an upward-facing surface of an attic floor or above a ceiling of a structure.

Embodiment 84. An insulated structure having an interior surface and an exterior surface, and a borosilicate fiberglass insulation material according to any of embodiments 76-81 disposed in and at least partially filling a cavity between the interior surface and the exterior surface.

Embodiment 85. An insulated structure having an interior surface and an exterior surface, and a borosilicate fiberglass insulation material according to any of embodiments 76-81 disposed in and substantially filling a cavity between the interior surface and the exterior surface.

Embodiment 86. An insulated cavity having an interior surface and an exterior surface, and a borosilicate fiberglass insulation material according to any of embodiments 76-81 disposed in and a least partially filling (e.g., substantially filling) the cavity between the interior surface and the exterior surface.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended embodiments and their equivalents.

What is claimed is:

1. A method for making a borosilicate fiberglass insulation material comprising a plurality of borosilicate glass fibers, the method comprising:
providing a borosilicate fiberglass comprising a plurality of borosilicate glass fibers; and
irradiating the plurality of borosilicate glass fibers of the borosilicate fiberglass with an electron beam.

2. The method according to claim 1, wherein the plurality of borosilicate glass fibers of the borosilicate fiberglass insulation material has a boron content of at least 3 wt % on an oxide basis.

3. The method according to claim 1, wherein the plurality of borosilicate glass fibers of the borosilicate fiberglass insulation material has a boron content of at least 6 wt % on an oxide basis.

4. The method according to claim 1, wherein the plurality of borosilicate glass fibers of the borosilicate fiberglass insulation material has a silicon content of at least 50 wt % on an oxide basis.

5. The method according to claim 1, wherein the median length of the plurality of borosilicate glass fibers is no more than 100 mm.

6. The method according to claim 1, wherein the plurality of borosilicate glass fibers is at a temperature of no more than 500° C. when it is irradiated with the electron beam.

7. The method according to claim 1, wherein the dose of the electron beam is at least 250 kGy.

8. The method according to claim 1, wherein the dose of electron beam irradiation is at least 5 MGy.

9. The method according to claim 1, wherein the dose of electron beam irradiation is at least 50 MGy.

10. The method according to claim 1, wherein the energy of the electron beam irradiation is at least 100 keV.

11. The method according to claim 1, wherein the irradiation with the electron beam provides the plurality of borosilicate glass fibers with a BO3/BO4 ratio that is greater than a BO3/BO4 ratio of an otherwise identical non-irradiated borosilicate glass fibers by at least 0.02.

12. The method according to claim 1, wherein the irradiation with the electron beam provides the plurality of borosilicate glass fibers with a BO3/BO4 ratio that is greater than a BO3/BO4 ratio of an otherwise identical non-irradiated borosilicate glass fibers by at least 0.1.

13. The method according to claim 1, wherein the plurality of borosilicate glass fibers of the borosilicate glass insulation material has a BO3/BO4 ratio of at least 0.77.

14. The method according to claim 1, wherein the plurality of the borosilicate glass fibers of the borosilicate glass insulation material has a BO3/BO4 ratio of at least 0.85.

15. The method according to claim 1, wherein the e-beam irradiation of the glass fibers provides the insulation material with an N′ value that is at least 2.5 greater than the N′ value of an otherwise insulation material comprising an otherwise identical plurality of non-irradiated borosilicate glass fibers.

16. A borosilicate fiberglass insulation material comprising a plurality of electron beam-irradiated borosilicate glass fibers.

17. A borosilicate fiberglass insulation material according to claim 16, wherein the plurality of borosilicate glass fibers of the borosilicate glass insulation material has a BO3/BO4 ratio of at least 0.79.

18. An insulated structure having an interior surface, and a borosilicate fiberglass insulation material according to claim 16 disposed against the interior surface.

19. An insulated structure having an interior surface and an exterior surface, and a borosilicate fiberglass insulation material according to claim 16 disposed in and at least partially filling a cavity between the interior surface and the exterior surface.

20. An insulated cavity having an interior surface and an exterior surface, and a borosilicate fiberglass insulation material according to claim 16 disposed in and a least partially filling the cavity between the interior surface and the exterior surface.
